(19) United States
(12) Patent Application Publication
(10) Pub. No.: US 2010/0297314 A1
(43) Pub. Date: Nov. 25, 2010

(54) ICE CREAM CONE MAKING PROCESSES AND STRUCTURES

(76) Inventor: PERRY CHARLES BOGAL, Scottsdale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/468,780

(22) Filed: May 19, 2009

(51) Int. Cl. A23G 9/50; A23G 9/48

(52) U.S. Cl. 426/283

(57) ABSTRACT

A process of making individual ice cream snack pieces includes providing bite-sized ice cream cone shells each including an open top and an opposed closed bottom, an inner surface and an opposed outer surface extending between the open top and the closed bottom, and the inner surface bounding an interior volume, applying ice cream to the interior volumes of the bite-sized ice cream cone shells to extend between the open top and the closed bottom of each of the bite-sized ice cream cone shells to form bite-sized ice cream-filled cones, and freezing the bite-sized ice cream-filled cones to form frozen bite-sized ice cream cone snack pieces.

### FIELD OF THE INVENTION

The present invention relates to processes for making food products and, more particularly, the process for making frozen food products incorporating frozen desert material, such as ice cream.

### BACKGROUND OF THE INVENTION

An ice cream cone or cornet is a hollow, often cone-shaped, pastry made of a wafer or wafer-like material, often similar in texture to a waffle, in which ice cream is served, allowing it to be eaten without a bowl or spoon. Various types of ice cream cones include waffle cones, cake or wafer cones, and sugar cones.

The ice cream cone was invented in the early 1900's, and since have become a popular and widely-enjoyed form of dessert. Since the advent of the ice cream cone, many efforts have been made to improve the process for making ice cream cones, and the edible materials used to make ice cream cones. Other than this, little effort has been made to provide improved ice cream cone products.

### SUMMARY OF THE INVENTION

According to the principle of the invention, a process of making an ice cream cone product includes providing a first pastry shell having first size defined by the first pastry shell having a first open top and an opposed first closed bottom, a first inner surface and an opposed first outer surface extending between the first open top and the first closed bottom, the first inner surface bounding a first interior volume holding first ice cream extending between the first open top and the first closed bottom, and providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream. The second size of the second pastry shell is greater than the first size of the first pastry shell. Next is installing the first pastry shell with respect to the second pastry shell by positioning the first pastry shell into the second volume of the second pastry shell to concurrently apply the first closed bottom and the first outer surface of the first pastry shell against the second closed bottom and the second inner surface proximate to the second closed bottom of the second pastry shell, respectively, and the first pastry shell extends upwardly into the second volume from the first closed bottom to the first open top directed upwardly into the second volume facing the second open top, and the first pastry shell, and the ice cream held in the first volume, occupying a portion of the second interior volume extending from the second closed bottom of the second pastry shell to an intermediate position of the second interior volume between the second closed bottom and the second open top. The first size of the first pastry shell is bite-sized. Further to the present method is a step of applying second ice cream to the second volume of the second pastry shell through the second open top of the second pastry shell. The first and second pastry shells are each preferably formed in a shape of a cone.

According to the principle of the invention, a process of making an ice cream cone product includes providing a first pastry shell having first size defined by the first pastry shell having a first open top and an opposed first closed bottom, a first inner surface and an opposed first outer surface extending between the first open top and the first closed bottom, the first inner surface bounding a first interior volume to receive ice cream, and providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream. The second size of the second pastry shell is greater than the first size of the first pastry shell. Next is installing the first pastry shell with respect to the second pastry shell by positioning the first pastry shell into the second volume of the second pastry shell to concurrently juxtapose the first closed bottom and the first outer surface of the first pasty with respect to the second closed bottom and the second inner surface proximate to the second closed bottom of the second pastry shell, respectively, and the first pastry shell extends upwardly into the second volume from the first closed bottom to the first open top directed upwardly into the second volume facing the second open top, and the first pastry shell occupying a portion of the second interior volume extending from the second closed bottom of the second pastry shell to an intermediate position of the second interior volume between the second closed bottom and the second open top. Still further is applying an edible seal between the first outer surface of the first pastry shell and the second inner surface of the second pastry shell to prevent melted ice cream from migrating to the second closed bottom of the second pastry shell between the first outer surface of the first pastry shell and the second inner surface of the second pastry shell. The first size of the first pastry shell is bite-sized. Still further to the present method is applying first ice cream into the first volume of the first pastry shell through the first open top of the first pastry shell to substantially fill the first volume of the first pastry shell with the first ice cream extending between the first closed bottom of the first pastry shell and the first open top of the first pastry shell, and freezing the first ice cream applied to the first volume of the first pastry shell. A step of applying second ice cream to the second volume through the second open top of the second pastry shell is then carried out, and the edible seal between the first outer surface of the first pastry shell and the second inner surface of the second pastry shell preventing melted second ice cream from migrating to the second closed bottom of the second pastry shell between the first outer surface of the first pastry shell and the second inner surface of the second pastry shell.

According to the principle of the invention, a process of making an ice cream cone product includes providing a first pastry shell having first size defined by the first pastry shell having a first open top and an opposed first closed bottom, a first inner surface and an opposed first outer surface extending between the first open top and the first closed bottom, the first inner surface bounding a first interior volume to receive ice cream, and providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream. The second size of the second pastry shell is greater than the first size of the first pastry shell. Next is providing a viscous hardenable candy, and installing the first pastry shell with respect to the second pastry shell by positioning the first pastry shell into the second volume of the second pastry shell to concurrently juxtapose the first closed bottom and the first outer surface of the first pasty with respect to the second closed bottom and the second inner surface proximate to the second closed bottom of the second pastry shell, respectively, and the first pastry shell extends upwardly into the second volume from the first closed bottom to the first open top directed upwardly into the second volume facing the second open top, and first pastry shell occupying a portion of the second interior volume extending from the second closed bottom of the second pastry shell to an intermediate position of the second interior volume between the second closed bottom and the second open top. Further is applying the viscous hardenable candy between the first outer surface of the first pastry shell and the second inner surface of the second pastry shell, and hardening the viscous hardenable candy to form an edible hardened candy seal between the first outer surface of the first pastry shell and the second inner surface of the second pastry shell to prevent melted ice cream from migrating to the second closed bottom of the second pastry shell between the first outer surface of the first pastry shell and the second inner surface of the second pastry shell. The first size of the first pastry shell is bite-sized. Further to the present embodiment are applying first ice cream into the first volume of the first pastry shell through the first open top of the first pastry shell to substantially fill the first volume of the first pastry shell with the first ice cream extending between the first closed bottom of the first pastry shell and the first open top of the first pastry shell, and freezing the first ice cream applied to the first volume of the first pastry shell, which is follows by applying second ice cream into the second volume through the second open top of the second pastry shell, and the edible hardened candy seal between the first outer surface of the first pastry shell and the second inner surface of the second pastry shell preventing melted second ice cream from migrating to the second closed bottom of the second pastry shell between the first outer surface of the first pastry shell and the second inner surface of the second pastry shell.

According to the principle of the invention, a process of making individual ice cream snack pieces includes providing bite-sized ice cream cone shells each including an open top and an opposed closed bottom, an inner surface and an opposed outer surface extending between the open top and the closed bottom, and the inner surface bounding an interior volume, providing ice cream, applying the ice cream to the interior volumes of the bite-sized ice cream cone shells to extend between the open top and the closed bottom of each of the bite-sized ice cream cone shells to form bite-sized ice cream-filled cones, and freezing the bite-sized ice cream-filled cones to form frozen bite-sized ice cream cone snack pieces. The process further includes bulk packaging the frozen bite-sized ice cream cone snack pieces.

### BRIEF DESCRIPTION OF THE DRAWINGS

Referring to the drawings:

FIG. 1 is schematic illustration showing the steps in a process of making an ice cream cone product;

FIG. 2 is a perspective view of bulk-packaged frozen bite-sized ice cream cone snack pieces;

FIG. 3 is flow chart showing a process of making bite-sized ice cream cone snack pieces;

FIG. 4 is a vertical sectional view of an ice cream cone product produced from the process illustrated in FIG. 1;

FIG. 5 is schematic illustration showing the steps in a process of making a bite-sized ice cream cone snack piece;

FIG. 6 is a sectional view taken along line 6-6 of FIG. 4;

FIG. 7 is a sectional view taken along line 7-7 of FIG. 5;

FIG. 8 is an enlarged fragmentary a vertical sectional view of an ice cream cone product produced from the process illustrated in FIG. 5; and

FIG. 9 is a perspective view of frozen bite-sized ice cream cone snack pieces bulk-packaged according to an alternate embodiment of the invention.

### DETAILED DESCRIPTION OF A PREFERRED EMBODIMENT

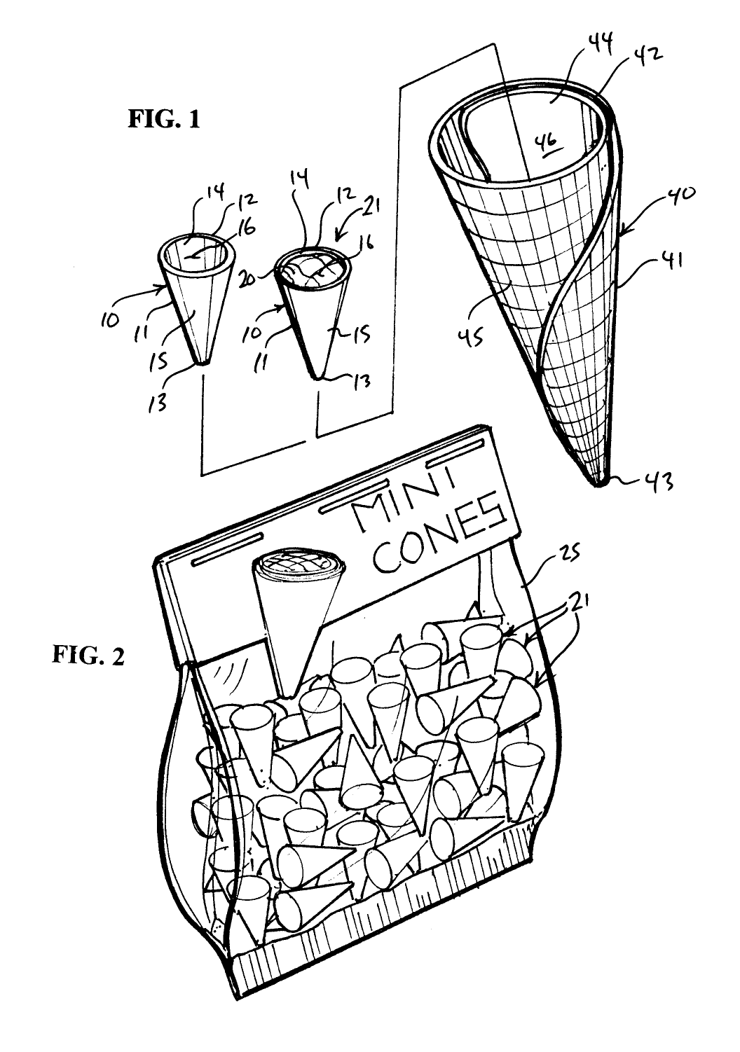

Turning now to the drawings, in which like reference characters indicate corresponding elements throughout the several views, attention is first directed to FIG. 1, which is a schematic illustration showing the steps in a process of making a frozen bite-sized ice cream cone snack, and of making an ice cream cone product. The process of making a frozen bite-sized ice cream cone snack first includes providing a pastry shell 10. Pastry shell 10 is an ice cream cone pastry shell, and includes a continuous sidewall 11 having an open top 12 and an opposed closed bottom 13, an inner surface 14 and an opposed outer surface 15 extending between open top 12 and closed bottom 13. Inner surface 14 bounds an interior volume 16 of pastry shell 10, which is to receive and hold ice cream to extend between open top 12 and closed bottom 13.

Pastry shell 10 is made of edible pastry material, such as edible wafer, in which ice cream is served allowing it to be eaten without a spoon or bowl. Pastry shell 10 is bite-sized, is formed in the shape of a cone and, more particularly, is formed of edible sugar cone material in the present embodiment. Pastry shell 10 is, according to the present embodiment, a bite-sized sugar cone, and is formed and constructed in accordance with known ice cream cone pastry material and with known ice cream cone making techniques, further details of which will readily occur to the skilled artisan and will not be discussed in further detail.

Having provided pastry shell 10, the process of making a frozen bite-sized ice cream cone snack then includes filling pastry shell 10 with a volume or amount of ice cream 20 by providing ice cream 20 and applying ice cream 20 into interior volume 16 through open top 12 to fill, or at least substantially fill, interior volume 16 with ice cream 20 extending substantially between open top 12 and closed bottom 13, which forms a bite-sized ice cream-filled pastry shell or cone, which is then placed in a freezer until frozen to thereby freeze ice cream 20 to form a frozen bite-sized ice cream cone snack or snack piece denoted generally at 21 in FIG. 1. Ice cream may be of any flavor or type of frozen dessert or dessert material. Prior to filling pastry shell 10 with ice cream 20, inner surface 14 may be coated with one or more layers of oil, sugar and chocolate, or other selected edible coating, to insulate pastry shell 10 from ice cream 20 to prevent ice cream 20 from making pastry shell 10 soggy. Alternately, before filling pastry shell 10 with ice cream 10, pastry shell 10 may be coated or encapsulated in chocolate or other like or similar candy or edible coating.

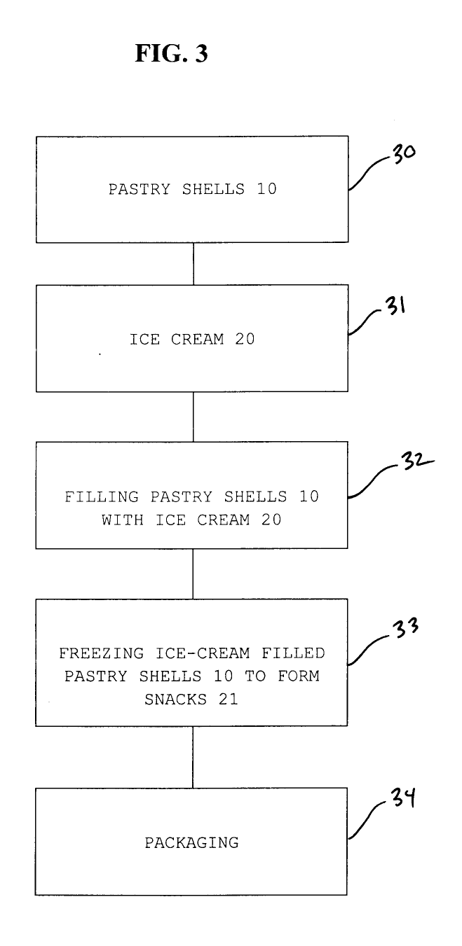

A large quantity of frozen bite-sized ice cream cone snacks or snack pieces can be made with reference to FIG. 1 in a series of process steps referenced in FIG. 3 including a step 30 of providing a quantity of pastry shells 10, a step 31 of providing a quantity of ice cream 20, a step 32 of filling pastry shells 10 with ice cream 20 to form bite-sized ice cream-filed pastry shells or cones, and a step 33 of freezing the ice cream-filled pastry shells or cones to form frozen bite-sized ice cream cone snacks 21. The formed snacks 21 may then be packaged in a step 34 for consumer sale, such as by bulk-packaging snacks 21 in a container such as a box, a clear flexible plastic bag 25 illustrated in FIG. 2, a clear, compartmentalized, plastic packaging container 26 illustrated in FIG. 9, or other selected packaging. Snacks 21 may be individually wrapped, if desired, prior to bulk packaging. Snacks 21 may also be individually wrapped for individual sale. Because snacks are bite-sized, they are each easily consumed in one bite to provide a convenient, satisfying, one-bite snack. Bulk packaged snacks 21 may contain 10 snacks 21, 20 snacks 21, 50 snacks, 100 snacks 21, etc.

Snack 21 is useful not just as a satisfying snack, but also in making an ice cream cone product. A process of making an ice cream cone product with snack 21 includes, of course, providing snack 21, in addition to providing a pastry shell 40 illustrated in FIG. 1. Pastry shell 40 is an ice cream cone pastry shell, and includes a continuous sidewall 41 having an open top 42 and an opposed closed bottom 43, an inner surface 44 and an opposed outer surface 45 extending between open top 42 and closed bottom 43. Inner surface 44 bounds an interior volume 46 of pastry shell 10, which is to receive and hold ice cream. Pastry shell 40 is made of edible pastry material, such as an edible wafer, in which ice cream is served allowing it to be eaten without a spoon or bowl. Pastry shell 40 is formed in the shape of a cone and, more particularly, is formed of edible sugar cone material in the present embodiment like that of pastry shell 10. Pastry shell 40 is, according to the present embodiment, a standard sugar cone, has a size commensurate with a standard sugar cone, and is formed and constructed in accordance with known ice cream cone pastry material and with known ice cream cone making techniques, further details of which will readily occur to the skilled artisan and will not be discussed in further detail. A standard sugar cone a radius of approximately 2.5 cm and a slant height of approximately 11.5 cm, and pastry shell 40 is preferably formed of this approximate, standard size. Being bite-sized, pastry shell is approximately 30% the size of pastry shell 40, having a radius of approximately 0.75 cm, and a slant height of approximately 3.5 cm. Pastry shells 10 and 14 are commensurate in shape or otherwise similarly shaped.

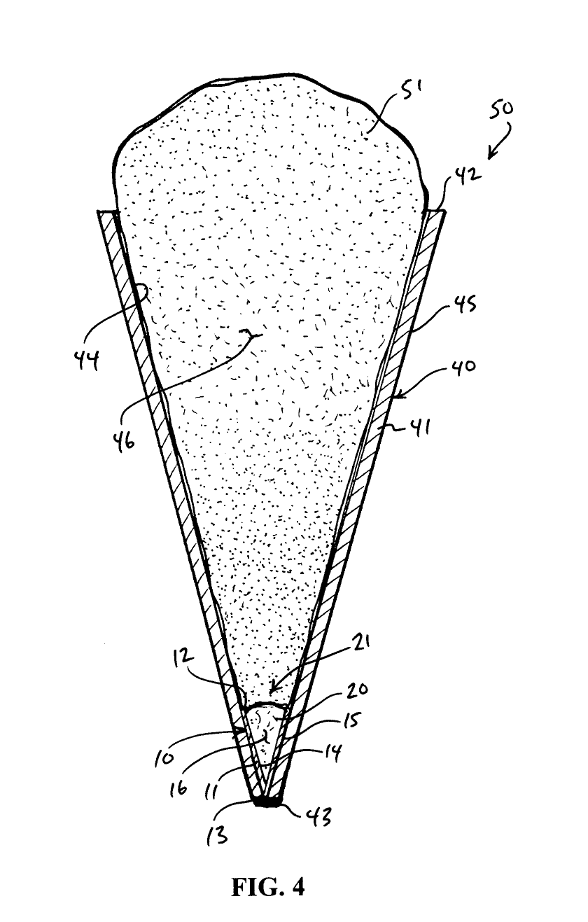

To utilize snack 21 with pastry shell 40, pastry shell 10, which is filled with ice cream 20, is installed with respect to pastry shell 40 by positioning pastry shell 10 bottom first into volume 46 of pastry shell 40 through open top 42, and is applied into closed bottom 43 of pastry shell 40 to concurrently apply closed bottom 13 and outer surface 15 of pastry shell 10 against closed bottom 43 and inner surface 44 proximate to closed bottom 43 of pastry shell 40, respectively, as illustrated in FIG. 4, such that in this positioning pastry shell 10 extends upwardly into volume 46 of pastry shell 40 from closed bottom 13 at closed bottom 43 of pastry shell 40 to open top 12 directed upwardly into volume 46 facing open top 42 of pastry shell 40. In this installation of snack 21 with respect to pastry shell 40 pastry shell 10, and ice cream 20 held in volume 16 of pastry shell 10 filling pastry shell 10, occupying a portion of the volume 46 of pastry shell 40 extending from closed bottom 43 of pastry shell 40 to an intermediate position of volume 46 between closed bottom 43 of pastry shell 40 and open top 42 of pastry shell 40. As clearly illustrated in FIG. 4, the portion of volume 46 occupied by snack 21 is considerably less than the remaining portion of volume 46 extending from open top 12 of snack 21 to open top 42 of pastry shell. Having installed snack 21 with respect to pastry shell 40 as illustrated in FIG. 4, an ice cream cone product 50 is formed. Having formed ice cream cone product 50, in use ice cream 51 is applied to volume 46 of pastry shell 40 through open top 42 of pastry shell 40, which point all may then be eaten. In FIG. 4, ice cream 51 applied into volume 46 extends from open top 12 of snack 21 to open top 42 of pastry shell 40, and extends outwardly in mound above and away from open top 42 of pastry shell 40, and this is illustrated simply by way of example. The provision of snack 21 at closed bottom 43 of pastry shell 40 provides a user eating the finished produce with a satisfying ending treat, particularly in the case where the flavor of ice cream 20 is different from the flavor of ice cream 51 in a preferred embodiment.

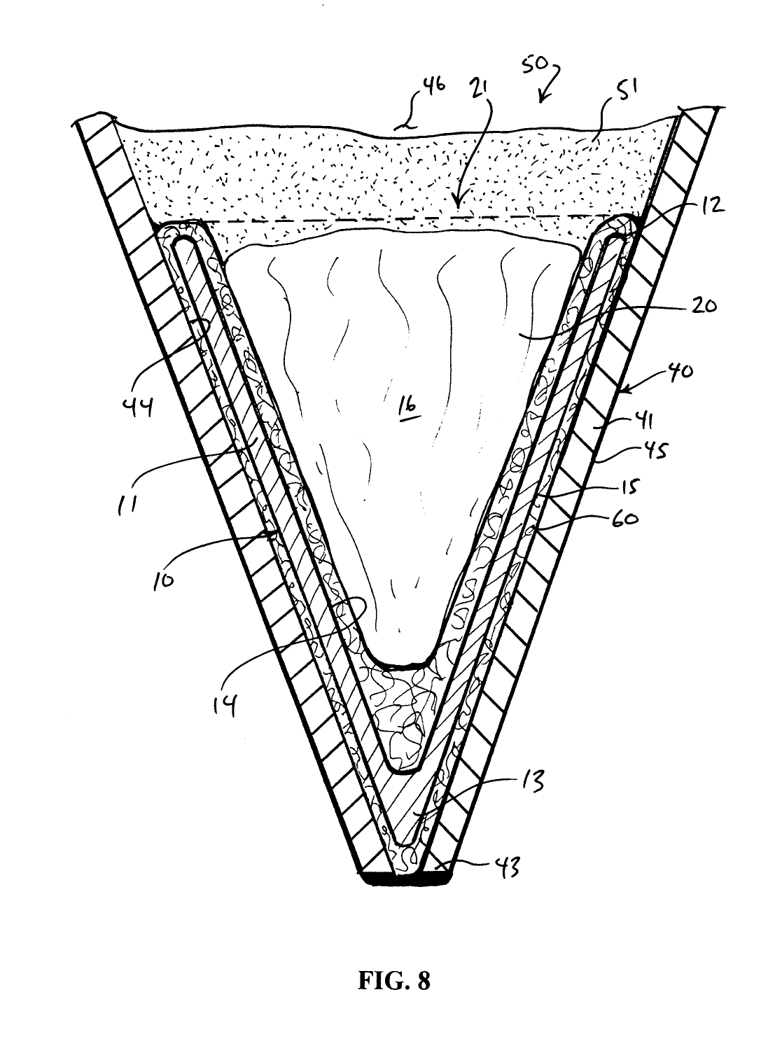

In the process of installing pastry shell 10 with respect to pastry shell 40 as discussed above, the process of forming ice cream cone product 50 includes in a further embodiment, and with reference to FIG. 8, applying an edible seal 60 between outer surface 15 of pastry shell 10 and inner surface 44 of pastry shell 40. Edible seal 60 not only secures pastry shell 10 to pastry shell 40, but also prevents melted ice cream from migrating to closed bottom 43 of pastry shell 40 between outer surface 15 of pastry shell 10 and inner surface 44 of pastry shell 40, to prevent closed bottom 43 of pastry shell 40 from becoming soggy and dripping melted ice cream. Edible seal 60 is formed of one or more layers of oil, sugar and chocolate in a particular example, or other like or similar material of whatever flavor or a sugar or candy syrup or like candy or candy-like material in another example, and substantially seals outer surface 15 of pastry shell 10 to inner surface 44 of pastry shell 40 to form a substantially melted-ice cream impervious edible seal between outer surface 15 of pastry shell and inner surface 44 of pastry shell 40 to prevent melted ice cream from migrating to closed bottom 43 of pastry shell 40 between outer surface 15 of pastry shell 10 and inner surface 44 of pastry shell 40, to prevent closed bottom 43 of pastry shell 40 from becoming soggy and dripping melted ice cream. In the present example, seal 60 is applied to the entire outer surface 15 of pastry shell 10 and over closed bottom 13 of pastry shell 10 to provide a seal between not only outer surface 15 of pastry shell 10 and inner surface 44 of pastry shell 40, but also between closed bottom 13 of pastry shell 10 and closed bottom 43 of pastry shell 40. In the present example, the edible material forming seal 60 extends to, and is also applied in the form of one or more layers, to inner surface 14 of pastry shell 10 and across closed bottom 13 of pastry shell 10 within volume 15, which insulates pastry shell 10 from ice cream 20 applied to volume 16 to prevent ice cream 20 from making pastry shell 10 soggy.

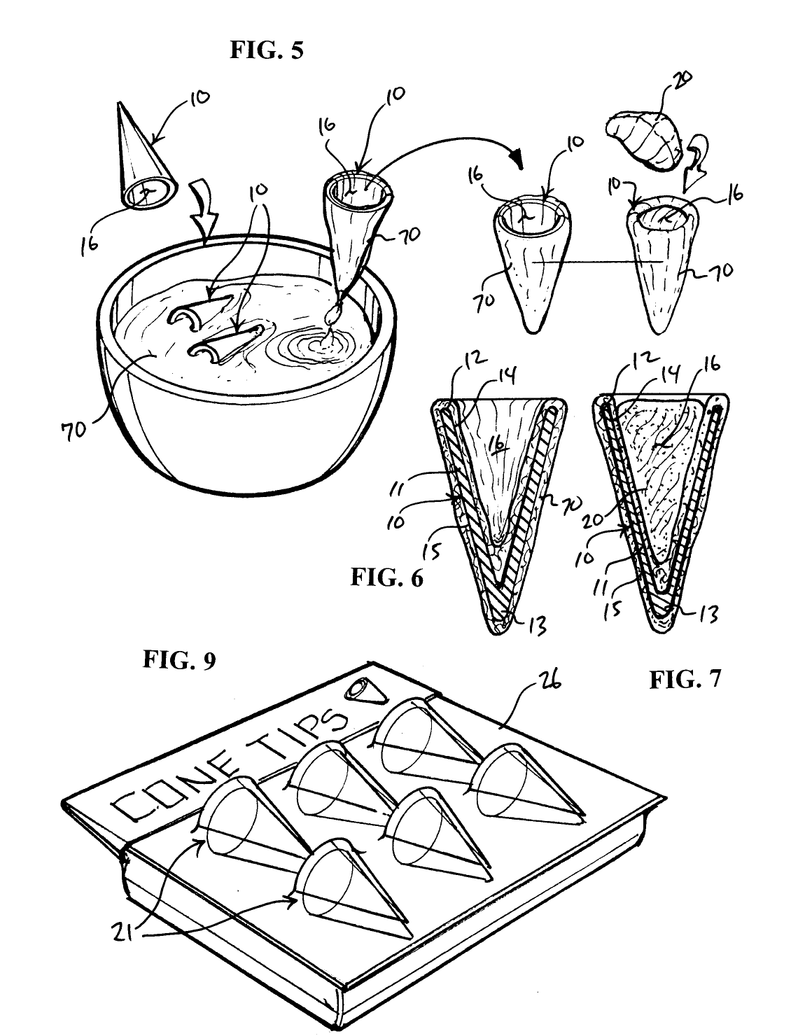

A process of forming ice cream cone product 50 with edible seal 60 illustrated in FIG. 8 includes providing pastry shells 10 and 40 as before. Looking to FIG. 5, the process involves providing a quantity or mass of a settable or hardenable viscous candy 70, coating pastry shell 10 in one or more layers of viscous candy 70, filling pastry shell 10 with ice cream 20 as before, and installing pastry shell 10 with respect to pastry shell 40 as before as illustrated in FIG. 8. With the application of viscous candy 70 encapsulating or coating pastry shell 10, viscous candy 70 is formed between outer surface 15 of pastry shell 10 and inner surface 44 of pastry shell 40, between closed bottom 13 of pastry shell 10 and closed bottom 43 of pastry shell 40, and between inner surface 14 and closed bottom 13 of pastry shell 10 and ice cream 20 placed in volume. At this point, viscous candy 70 is set or hardened, or otherwise allowed to set or harden, to form edible set or hardened candy seal 60 between outer surface 15 of pastry shell 10 and inner surface 44 of pastry shell 40, between closed bottom 13 of pastry shell 10 and closed bottom 43 of pastry shell 40, and also between inner surface 14 and closed bottom 13 of pastry shell 10 and ice cream 20 applied to volume 16 of pastry shell 10 to insulate pastry shell 10 from ice cream 20 applied to volume 16 to prevent ice cream 20 from making pastry shell 10 soggy. With pastry shell 10 installed with respect to pastry shell 40 and sealed to pastry shell 40 with seal 60 and filled with ice cream 20, ice cream 51 is applied to volume 46 of pastry shell 40 as before, at which point all may then be eaten.

Coating or encapsulating pastry shell 10 with viscous candy 70 in a particular example with reference to FIG. 5 involves taking up a pastry shell 10, dipping pastry shell 10 into a mass of viscous candy 70 to encapsulate pastry shell 10 in one or more layers of viscous candy, removing pastry shell 10 from the mass of viscous candy, and waiting momentarily, such as anywhere from 5-10 seconds, to allow any excess viscous candy 70 to drip away from pastry shell 10. FIG. 6 is a sectional view taken along line 6-6 of FIG. 5 illustrating pastry shell 10 coated or otherwise encapsulated with viscous candy 70. A further step is then carried out, which includes filling pastry shell 10 with ice cream 20 as illustrated in FIG. 5. FIG. 7 a sectional view taken along line 7-7 of FIG. 5 illustrating pastry shell 10 coated or otherwise encapsulated with viscous candy 70 and filled with ice cream 20. Completion of the process of forming the ice cream cone product includes, as before, installing pastry shell 10 encapsulated in viscous candy 70 and filled with ice cream 20 with respect to pastry shell 11, and then an additional step of hardening viscous candy 70 to set or harden viscous candy 70 to form seal 60 with reference to FIG. 8. Again, seal 60 additionally acts as an edible adhesive adhesively securing pastry shell 11 to pastry shell 40. In a preferred embodiment, viscous candy 70 is melted chocolate, which is a mixture of oil, sugar and chocolate that has been heated sufficiently to be melted. Hardening of viscous candy 70 is preferably carried out in a freezing process by freezing the installed pastry shells 10 and 40 in a freezer, which not only hardens viscous candy 70 but also freezes ice cream 20 applied to volume 16. In other embodiments, pastry shell 10 may be coated or otherwise encapsulated with viscous candy by spraying techniques, painting techniques, coating techniques, etc. Again, in other embodiments, viscous candy 70 can be of a like or similar material to that of melted chocolate and of any selected flavor, and may also be a sugar or candy syrup or like candy or candy-like material.

In an alternate process, pastry shell 10 coated with viscous candy 70 as illustrated in FIG. 6 is not filled with ice cream, and is rather installed directly with respect to pastry shell 40 and then viscous candy 70 is hardened as before for form seal 60. With pastry shell 10 installed with respect to pastry shell 40 and sealed to pastry shell 40 with seal 60, an exemplary ice cream cone product is formed. A further step in this alternate method may then include filling pastry shell 10 with ice cream 20 as before, and a freezing process may then be carried out to freeze ice cream 20 if so desired. With pastry shell 10 installed with respect to pastry shell 40 and sealed to pastry shell 40 with seal 60 and filled with ice cream 20, ice cream 51 is applied to volume 46 of pastry shell 40 as before, at which point all may then be eaten.

The present invention is described above with reference to preferred embodiments. However, those skilled in the art will recognize that changes and modifications may be made in the described embodiments without departing from the nature and scope of the present invention. For instance, although pastry shells 10 and 40 are each disclosed as sugar cones, other forms of ice cream cones can be used, if desired, such as waffle cones, cake or wafer cones, pretzel cones, and the like. Moreover, pastry shells 10 and 40 may be formed of any desired complementing shapes to allow pastry shell 10 to be installed with respect to pastry shell 40 in accordance with the teachings set forth in this specification. Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A process of making an ice cream cone product, comprising steps of:
providing a first pastry shell having first size defined by the first pastry shell having a first open top and an opposed first closed bottom, a first inner surface and an opposed first outer surface extending between the first open top and the first closed bottom, the first inner surface bounding a first interior volume holding first ice cream extending between the first open top and the first closed bottom;
providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream;
the second size of the second pastry shell greater than the first size of the first pastry shell; and
installing the first pastry shell with respect to the second pastry shell by positioning the first pastry shell into the second volume of the second pastry shell to concurrently apply the first closed bottom and the first outer surface of the first pastry shell against the second closed bottom and the second inner surface proximate to the second closed bottom of the second pastry shell, respectively, and the first pastry shell extends upwardly into the second volume from the first closed bottom to the first open top directed upwardly into the second volume facing the second open top; and
the first pastry shell, and the ice cream held in the first volume, occupying a portion of the second interior volume extending from the second closed bottom of the second pastry shell to an intermediate position of the second interior volume between the second closed bottom and the second open top.

2. The process of making an ice cream cone product according to claim 1, wherein the first size of the first pastry shell is bite-sized.

3. The process of making an ice cream cone product according to claim 1, further comprising applying second ice cream to the second volume of the second pastry shell through the second open top of the second pastry shell.

4. The process of making an ice cream cone product according to claim 1, wherein the first and second pastry shells are each formed in a shape of a cone.

5. A process of making an ice cream cone product, comprising steps of:
providing a first pastry shell having first size defined by the first pastry shell having a first open top and an opposed first closed bottom, a first inner surface and an opposed first outer surface extending between the first open top and the first closed bottom, the first inner surface bounding a first interior volume to receive ice cream;
providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream;
the second size of the second pastry shell greater than the first size of the first pastry shell;
installing the first pastry shell with respect to the second pastry shell by positioning the first pastry shell into the second volume of the second pastry shell to concurrently juxtapose the first closed bottom and the first outer surface of the first pasty with respect to the second closed bottom and the second inner surface proximate to the second closed bottom of the second pastry shell, respectively, and the first pastry shell extends upwardly into the second volume from the first closed bottom to the first open top directed upwardly into the second volume facing the second open top;
the first pastry shell occupying a portion of the second interior volume extending from the second closed bottom of the second pastry shell to an intermediate position of the second interior volume between the second closed bottom and the second open top; and
applying an edible seal between the first outer surface of the first pastry shell and the second inner surface of the second pastry shell to prevent melted ice cream from migrating to the second closed bottom of the second pastry shell between the first outer surface of the first pastry shell and the second inner surface of the second pastry shell.

6. The process of making an ice cream cone product according to claim 5, wherein the first size of the first pastry shell is bite-sized.

7. The process of making an ice cream cone product according to claim 5, further comprising applying first ice cream into the first volume of the first pastry shell through the first open top of the first pastry shell to substantially fill the first volume of the first pastry shell with the first ice cream extending between the first closed bottom of the first pastry shell and the first open top of the first pastry shell.

8. The process of making an ice cream cone product according to claim 7, further comprising freezing the first ice cream applied to the first volume of the first pastry shell.

9. The process of making an ice cream cone product according to claim 7, further comprising:
applying second ice cream to the second volume through the second open top of the second pastry shell; and
the edible seal between the first outer surface of the first pastry shell and the second inner surface of the second pastry shell preventing melted second ice cream from migrating to the second closed bottom of the second pastry shell between the first outer surface of the first pastry shell and the second inner surface of the second pastry shell.

10. A process of making an ice cream cone product, comprising steps of:
providing a first pastry shell having first size defined by the first pastry shell having a first open top and an opposed first closed bottom, a first inner surface and an opposed first outer surface extending between the first open top and the first closed bottom, the first inner surface bounding a first interior volume to receive ice cream;
providing a second pastry shell having a second size defined by the second pastry shell having a second open top and an opposed second closed bottom, a second inner surface and an opposed second outer surface extending between the second open top and the second closed bottom, and the second inner surface bounding a second interior volume to receive ice cream;
the second size of the second pastry shell greater than the first size of the first pastry shell;
providing a viscous hardenable candy;
installing the first pastry shell with respect to the second pastry shell by positioning the first pastry shell into the second volume of the second pastry shell to concurrently juxtapose the first closed bottom and the first outer surface of the first pasty with respect to the second closed bottom and the second inner surface proximate to the second closed bottom of the second pastry shell, respectively, and the first pastry shell extends upwardly into the second volume from the first closed bottom to the first open top directed upwardly into the second volume facing the second open top;
the first pastry shell occupying a portion of the second interior volume extending from the second closed bottom of the second pastry shell to an intermediate position of the second interior volume between the second closed bottom and the second open top;
applying the viscous hardenable candy between the first outer surface of the first pastry shell and the second inner surface of the second pastry shell; and
hardening the viscous hardenable candy to form an edible hardened candy seal between the first outer surface of the first pastry shell and the second inner surface of the second pastry shell to prevent melted ice cream from migrating to the second closed bottom of the second pastry shell between the first outer surface of the first pastry shell and the second inner surface of the second pastry shell.

11. The process of making an ice cream cone product according to claim 10, wherein the first size of the first pastry shell is bite-sized.

12. The process of making an ice cream cone product according to claim 10, further comprising applying first ice cream into the first volume of the first pastry shell through the first open top of the first pastry shell to substantially fill the first volume of the first pastry shell with the first ice cream extending between the first closed bottom of the first pastry shell and the first open top of the first pastry shell.

13. The process of making an ice cream cone product according to claim 12, further comprising freezing the first ice cream applied to the first volume of the first pastry shell.

14. The process of making an ice cream cone product according to claim 13, further comprising:
applying second ice cream into the second volume through the second open top of the second pastry shell; and
the edible hardened candy seal between the first outer surface of the first pastry shell and the second inner surface of the second pastry shell preventing melted second ice cream from migrating to the second closed bottom of the second pastry shell between the first outer surface of the first pastry shell and the second inner surface of the second pastry shell.

15. A process of making individual ice cream snack pieces comprising steps of:
providing bite-sized ice cream cone shells each including an open top and an opposed closed bottom, an inner surface and an opposed outer surface extending between the open top and the closed bottom, and the inner surface bounding an interior volume;
providing ice cream;
applying ice cream to the interior volumes of the bite-sized ice cream cone shells to extend between the open top and the closed bottom of each of the bite-sized ice cream cone shells to form bite-sized ice cream-filled cones; and
freezing the bite-sized ice cream-filled cones to form frozen bite-sized ice cream cone snack pieces.

16. The process of making individual ice cream snack pieces according to claim 15, further comprising bulk packaging the frozen bite-sized ice cream cone snack pieces.
